(19) United States
(12) Patent Application Publication
(10) Pub. No.: US 2026/0251481 A1
(43) Pub. Date: Aug. 27, 2026

(54) MOTION DETECTION DEVICE AND VEHICLE STRUCTURE

(71) Applicant: Minebea AccessSolutions Inc., Miyazaki (JP)

(72) Inventors: Keigo KISHIMOTO, Miyazaki (JP); Norio SHIMIZU, Miyazaki (JP)

(21) Appl. No.: 19/541,680

(22) Filed: Feb. 17, 2026

(30) Foreign Application Priority Data
Feb. 26, 2025 (JP) 2025-028997

(51) Int. Cl. G01D 5/24; G01P 13/00

(52) U.S. Cl. CPC G01D 5/2405; G01P 13/00

(57) ABSTRACT

A motion detection device includes a first front detection portion and a first rear detection portion formed of a first electric wire and configured to detect electrostatic capacitance, and a sensor bracket, to which the first front detection portion and the first rear detection portion are attached. A recessed portion for adjusting a gap between the first front detection portion and the first rear detection portion is provided in a portion of the sensor bracket required to face a metal-made second supporter of a carrier member in such a manner that the gap is formed between the first front detection portion and the first rear detection portion.

### CROSS REFERENCE TO RELATED APPLICATION

This application claims benefit of priority to Japanese Patent Application 2025-028997, filed February 26, 2025, the entire content of which is incorporated herein by reference.

### BACKGROUND

### Technical Field

The present disclosure relates to a motion detection device and a vehicle structure.

### Background Art

Recently, as a motion detection device, a device configured to detect a motion of a human foot by an electrostatic capacitance sensor mounted on an elongated sensor bracket has been known (for example, see JP 2020-190483 A).

A loop-shaped electric wire forming a sensor electrode extends from a sensor main body of the electrostatic capacitance sensor. The electric wire includes first and second portions extending along a longitudinal direction of the sensor bracket, and folded portions continuously extending to ends of the first and second portions on the opposite side to the sensor main body side.

### SUMMARY

In a case where the above-described motion detection device of the related art is mounted on a vehicle, when a metal hitch member is present in the vicinity of the motion detection device, the first and second portions of the electric wire are disposed in a state of being spaced apart from each other at a portion being part of the sensor bracket and not facing the hitch member, but the first and second portions of the electric wire are disposed in a state of being in contact with each other at a portion of the sensor bracket facing the hitch member. Accordingly, for this reason, there is a problem that a range for detecting the motion of the human foot is narrowed in the vicinity of a portion of the sensor bracket facing the hitch member.

Under such circumstances, an object of the present disclosure is to provide a motion detection device and a vehicle structure that can prevent a motion detection range of an object from being narrowed.

A motion detection device according to a first aspect of the present disclosure includes:

first and second sensor electrodes that are formed of an electric wire and detect electrostatic capacitance; and

a sensor bracket to which the first and second sensor electrodes are attached, wherein

a gap adjustment portion is provided in a portion of the sensor bracket facing a metal component such that a gap is formed between the first sensor electrode and the second sensor electrode, the gap adjustment portion being configured to adjust the gap between the first sensor electrode and the second sensor electrode.

According to the above configuration, the gap adjustment portion is provided in the portion of the sensor bracket required to face the metal component. Since the gap adjustment portion adjusts the gap between the first sensor electrode and the second sensor electrode to form the gap between the first sensor electrode and the second sensor electrode, it is possible to prevent a motion detection range of an object (e.g., a foot of a person) from being narrowed in the vicinity of the portion of the sensor bracket required to face the metal component.

A motion detection device according to a second aspect of the present disclosure is such that, in the motion detection device according to the first aspect, the gap adjustment portion is a recessed portion provided in the portion of the sensor bracket required to face the metal component and is recessed in a direction away from the metal component.

According to the above configuration, since the recessed portion is recessed in a direction away from the metal component, even when the metal component vibrates, the metal component is unlikely to interfere. Therefore, the likelihood of the sensor bracket being damaged can be reduced.

Further, when the shape of the recess is set in accordance with the specifications of the metal component (particularly, the size in a vehicle up-down direction), the gap between the first sensor electrode and the second sensor electrode can also be easily adapted to the specifications of the metal component, thereby making it easy to secure a detection range necessary for each vehicle.

A motion detection device according to a third aspect of the present disclosure is such that, in the motion detection device according to the first aspect or the second aspect, the gap adjustment portion is provided with a holder holding the first and second sensor electrodes such that the first sensor electrode is located above the second sensor electrode when the sensor bracket is attached to a vehicle.

According to the above configuration, since the holder holds the first and second sensor electrodes such that the first sensor electrode is located above the second sensor electrode when the sensor bracket is attached to the vehicle, even when the sensor bracket is located on the metal component, the first sensor electrode can be disposed relatively far from the metal component, and the second sensor electrode can be disposed relatively close to the metal component. Therefore, it is possible to suppress an adverse effect received from the metal component in the motion detection of the object.

A motion detection device according to a fourth aspect of the present disclosure is such that, in the motion detection device according to any one of the first to third aspects, the sensor bracket is provided with a restriction portion is configured to restrict movement of the first and second sensor electrodes in a direction away from the sensor bracket.

According to the above configuration, the restriction portion restricts the first and second sensor electrodes from moving in the direction away from the sensor bracket, and therefore it is possible to prevent the motion detection range of the object from shifting from a predetermined range.

A motion detection device according to a fifth aspect of the present disclosure is such that, in the motion detection device according to the fourth aspect, the restriction portion is integrally formed on the sensor bracket.

According to the above configuration, the number of components is smaller when the restriction portion is integrally formed on the sensor bracket than when the restriction portion is separately formed on the sensor bracket. Accordingly, the integral formation of the restriction portion on the sensor bracket may contribute to simplification of the manufacturing process.

A motion detection device according to a sixth aspect of the present disclosure is such that, in the motion detection device according to the fourth aspect or the fifth aspect, the restriction portion is coupled to an edge portion of the sensor bracket, and is rotatable between a non-restriction position for being located outside the edge portion of the sensor bracket in a state of not overlapping the sensor bracket and a restriction position for pinching the first and second sensor electrodes with the sensor bracket in a state of overlapping the sensor bracket.

According to the above configuration, the restriction portion is coupled to the edge portion of the sensor bracket, and is rotatable between the non-restriction position for being located outside the edge portion of the sensor bracket in a state of not overlapping the sensor bracket and the restriction position for pinching the first and second sensor electrodes with the sensor bracket in a state of overlapping the sensor bracket.

With the above configuration, the restriction portion is rotatable between the non-restriction position and the restriction position, and therefore the position of the restriction portion can be easily switched from the non-restriction position to the restriction position.

A motion detection device according to a seventh aspect of the present disclosure includes:

the motion detection device according to any one of the first to sixth aspects; and

the metal component.

According to the above configuration, by providing the motion detection device mentioned above, the motion detection range of the object can be prevented from being narrowed in the vicinity of a portion of the sensor bracket required to face the metal component.

### BRIEF DESCRIPTION OF DRAWINGS

FIG. 1 is a schematic rear view of a vehicle adopting a vehicle structure according to an embodiment of the present disclosure.

FIG. 2 is a schematic view for explaining an opening/closing operation of a tail door of the vehicle.

FIG. 3 is a perspective view of a motion detection device and a carrier member according to the embodiment of the present disclosure as viewed from the rear left upper side.

FIG. 4 is a top view of the motion detection device.

FIG. 5 is a bottom view of the motion detection device.

FIG. 6 is a perspective view of the motion detection device as viewed from the rear left upper side.

FIG. 7 is a perspective view of the motion detection device as viewed from the rear left bottom side.

FIG. 8 is an enlarged view illustrating part of FIG. 7.

FIG. 9 is a bottom view of the part illustrated in FIG. 8.

FIG. 10 is an enlarged view illustrating part of FIG. 5.

FIG. 11 is an end view taken along a line XI-XI in FIG. 10.

FIG. 12 is an end view taken along a line XII-XII in FIG. 10.

FIG. 13 is an end view taken along a line XIII-XIII in FIG. 5.

FIG. 14 is a bottom view of the motion detection device in a state before completion.

FIG. 15 is an enlarged perspective view illustrating part of FIG. 14.

### DETAILED DESCRIPTION

Hereinafter, an embodiment of the present disclosure will be described with reference to the drawings. In the drawings, the same reference signs denote the same or corresponding components.

In addition, in the drawings, an X-axis, a Y-axis, and a Z-axis that are orthogonal to each other are illustrated as necessary. A direction parallel to the X-axis corresponds to a front-rear direction (length direction) of a vehicle, a direction parallel to the Y-axis corresponds to a left-right direction (width direction) of the vehicle, and a direction parallel to the Z-axis corresponds to an up-down direction (height direction) of the vehicle.

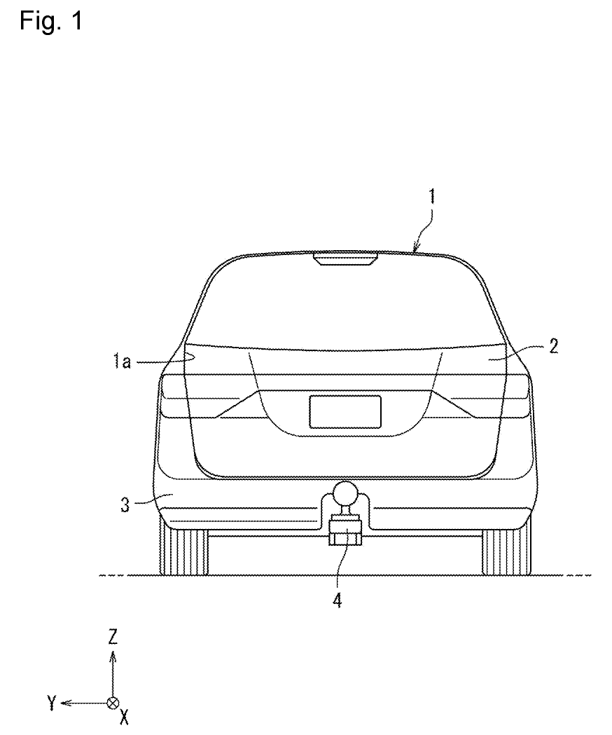

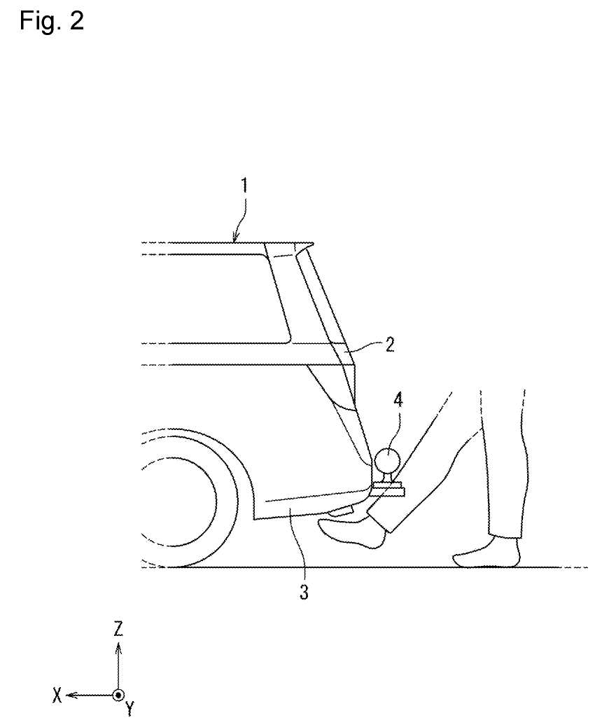

FIG. 1 is a schematic view of a vehicle adopting a vehicle structure according to the embodiment of the present disclosure as viewed from directly behind. FIG. 2 is a schematic view for explaining an opening/closing operation of a tail door 2 of the vehicle.

As illustrated in FIG. 1, the vehicle includes a car body 1 having an opening 1a at a rear portion thereof, a tail door 2 attached to the rear portion of the car body 1 and configured to open/close the opening 1a by rotating in the up-down direction, and a rear bumper 3 attached to the rear portion of the car body 1 and located below the opening 1a.

When a user opens/closes the tail door 2, the user performs a motion of moving his/her foot into a predetermined region of a space under the rear bumper 3 (hereinafter referred to as a "kick motion") as illustrated in FIG. 2.

As illustrated in FIGS. 1 and 2, the rear bumper 3 covers most of a carrier member 4 for towing a trailer such as a camping trailer or a boat trailer.

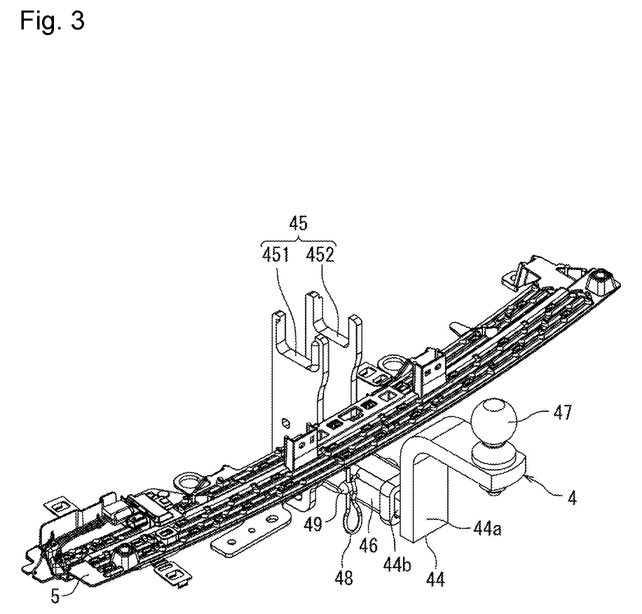

As illustrated in FIG. 3, the carrier member 4 includes a ball mount 44 and a hitch ball 47 fixed to a bent portion 44a on a rear side of the ball mount 44.

The ball mount 44 is supported by a first supporter 45 extending downward from a central portion in the left-right direction of a cross frame (not illustrated) and a second supporter 46 extending from a lower end portion of the first supporter 45 toward the rear of the vehicle. The first and second supporters 45 and 46, similar to other members of the carrier member 4, are made of metal. The second supporter 46 is an example of a metal component.

More specifically, the first supporter 45 is formed of first and second plates 451 and 452 pinching a front-end portion of the second supporter 46. On the other hand, the second supporter 46 is formed in a square tubular shape, and a straight portion 44b in front of the ball mount 44 is inserted into the second supporter 46. The straight portion 44b is detachably attached to the second supporter 46 by using a detachable pin 49 and a snap pin 48.

Although not illustrated, an upper end portion of the cross frame is fixed to the rear portion of the car body 1 via a cross frame of the carrier member 4 or the like. Only the second supporter 46 of the carrier member 4 is located directly under a motion detection device 5.

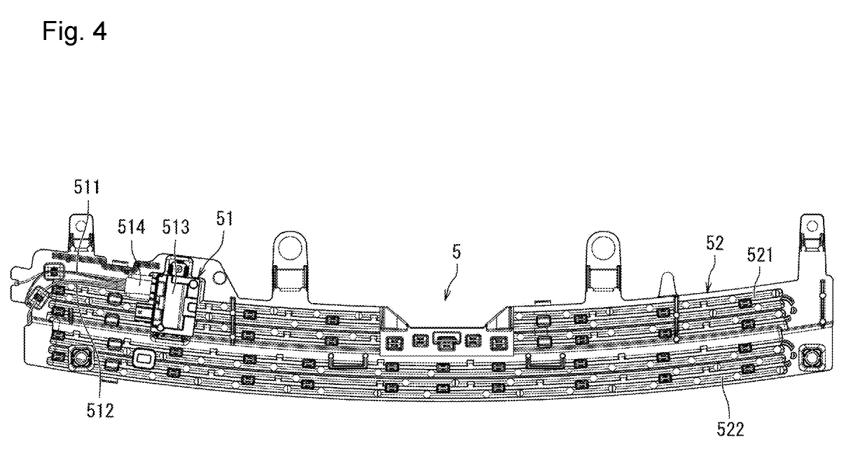

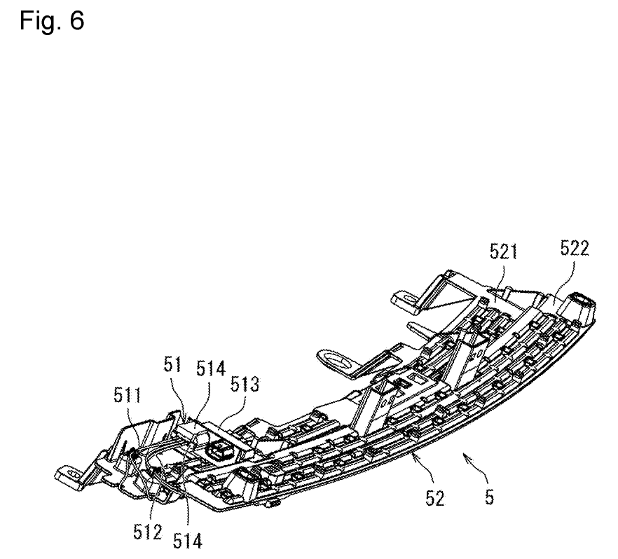

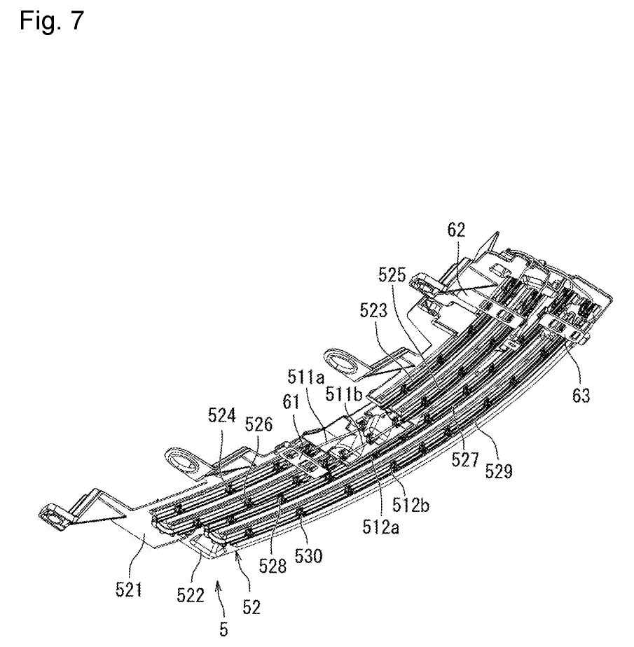

As illustrated in FIGS. 4 to 7, the motion detection device 5 includes a sensor unit 51 of an electrostatic capacitance non-contact type and a sensor bracket 52 made of resin, on which the sensor unit 51 is mounted. The motion detection device 5 is fixed to the rear portion of the car body 1 with a bolt or the like.

The sensor bracket 52 is formed in an elongated plate shape and extends along the left-right direction of the vehicle. A central portion in the longitudinal direction of the sensor bracket 52 is disposed between the first supporter 45 and the bent portion 44a on the rear side of the ball mount 44, and faces the second supporter 46 in the up-down direction. In other words, the central portion in the longitudinal direction of the sensor bracket 52 is disposed, above the second supporter 46, to be located rearward relative to the first supporter 45 and forward relative to the bent portion 44a (see FIG. 3).

The sensor bracket 52 includes a lower stage 521 and an upper stage 522 provided rearward relative to the lower stage 521 and located above the lower stage 521.

The sensor unit 51 includes first and second electric wires 511 and 512, and a controller 513 connected to end portions of the first and second electric wires 511 and 512 via a connector 514. The controller 513 is attached to an upper surface on the left side of the lower stage 521, and receives and processes detection signals from the first and second electric wires 511 and 512. The first electric wire 511 is an example of an electric wire.

The first electric wire 511 is routed to extend from a region on the upper surface of the lower stage 521 to a region under a lower surface of the lower stage 521 so as to draw a loop. The first electric wire 511 includes, under the lower surface of the lower stage 521, a first front detection portion 511a, a first rear detection portion 511b disposed rearward relative to the first front detection portion 511a, and a first connection portion 511c disposed rightward relative to the first front detection portion 511a and the first rear detection portion 511b. The first front detection portion 511a and the first rear detection portion 511b detect electrostatic capacitance. The electrostatic capacitance detected by the first front detection portion 511a and the first rear detection portion 511b changes when a foot of the user approaches the first front detection portion 511a and the first rear detection portion 511b. That is, the first front detection portion 511a and the first rear detection portion 511b are portions for detecting electrostatic capacitance that changes as the foot of the user approaches them. The first front detection portion 511a is an example of a first sensor electrode. The first rear detection portion 511b is an example of a second sensor electrode.

The first front detection portion 511a is inserted into a plurality of first front grooves 523 provided on the lower surface of the lower stage 521 and held by a plurality of first front holders 524. The plurality of first front grooves 523 are disposed at predetermined intervals along a front edge of the sensor bracket 52.

The first rear detection portion 511b is inserted into a plurality of first rear grooves 525 provided on the lower surface of the lower stage 521 and held by a plurality of first rear holders 526. The plurality of first rear grooves 525 are disposed at predetermined intervals along the front edge of the sensor bracket 52.

The first front grooves 523 and the first rear grooves 525 are respectively formed with a predetermined interval therebetween in the front-rear direction. With this, in a portion other than the central portion in the longitudinal direction of the lower stage 521, the first front detection portion 511a and the first rear detection portion 511b can be easily and reliably routed in a state of being separated from each other in the front-rear direction.

The first connection portion 511c is a portion having a semicircular arc shape in a bottom view of the first electric wire 511. The first connection portion 511c has one end portion continuously connected to a right end portion of the first front detection portion 511a and the other end portion continuously connected to a right end portion of the first rear detection portion 511b.

Further, the lower stage 521 of the sensor bracket 52 is integrally provided with first and second restriction portions 61 and 62 for restricting the first front detection portion 511a and the first rear detection portion 511b from moving in a direction away from the sensor bracket 52. The first and second restriction portions 61 and 62 are each an example of a restriction portion.

The second electric wire 512 is routed to extend from a region on the upper surface of the upper stage 522 to a region under a lower surface of the upper stage 522 so as to draw a loop. The second electric wire 512 includes, under the lower surface of the upper stage 522, a second front detection portion 512a, a second rear detection portion 512b disposed rearward relative to the second front detection portion 512a, and a second connection portion 512c disposed rightward relative to the second front detection portion 512a and the second rear detection portion 512b. Electrostatic capacitance detected by the second front detection portion 512a and the second rear detection portion 512b changes when a foot of the user approaches the second front detection portion 512a and the second rear detection portion 512b. That is, the second front detection portion 512a and the second rear detection portion 512b are portions for detecting electrostatic capacitance that changes as the foot of the user approaches them.

The second front detection portion 512a is inserted into a plurality of second front grooves 527 provided on the lower surface of the upper stage 522 and held by a plurality of second front holders 528. The plurality of second front grooves 527 are disposed at predetermined intervals along a rear edge of the sensor bracket 52.

The second rear detection portion 512b is inserted into a plurality of second rear grooves 529 provided on the lower surface of the upper stage 522 and held by a plurality of second rear holders 530. The plurality of second rear grooves 529 are disposed at predetermined intervals along the rear edge of the sensor bracket 52.

The second front grooves 527 and the second rear grooves 529 are respectively formed with a predetermined interval therebetween in the front-rear direction. With this, in the overall upper stage 522, the second front detection portion 512a and the second rear detection portion 512b can be easily and reliably routed in a state of being separated from each other in the front-rear direction.

The second connection portion 512c is a portion having a semicircular arc shape in a bottom view of the second electric wire 512. The second connection portion 512c has one end portion continuously connected to a right end portion of the second front detection portion 512a while the other end portion continuously connected to a right end portion of the second rear detection portion 512b.

Further, the upper stage 522 of the sensor bracket 52 is integrally provided with a third restriction portion 63 for restricting the second front detection portion 512a and the second rear detection portion 512b from moving in a direction away from the sensor bracket 52. The third restriction portion 63 is an example of the restriction portion.

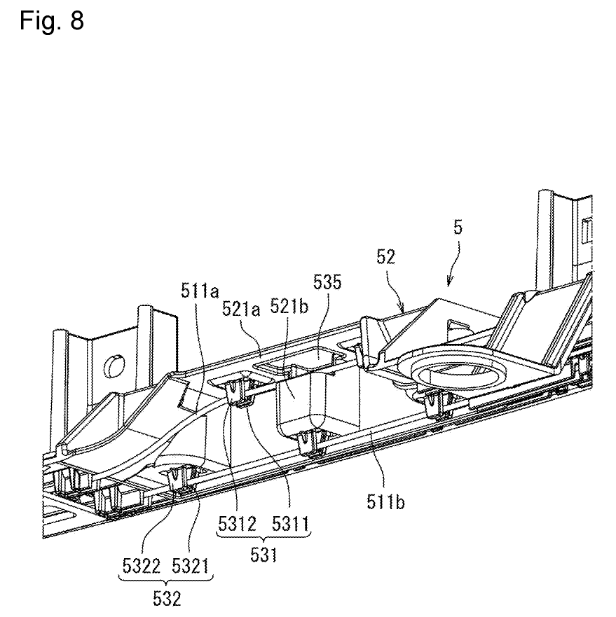

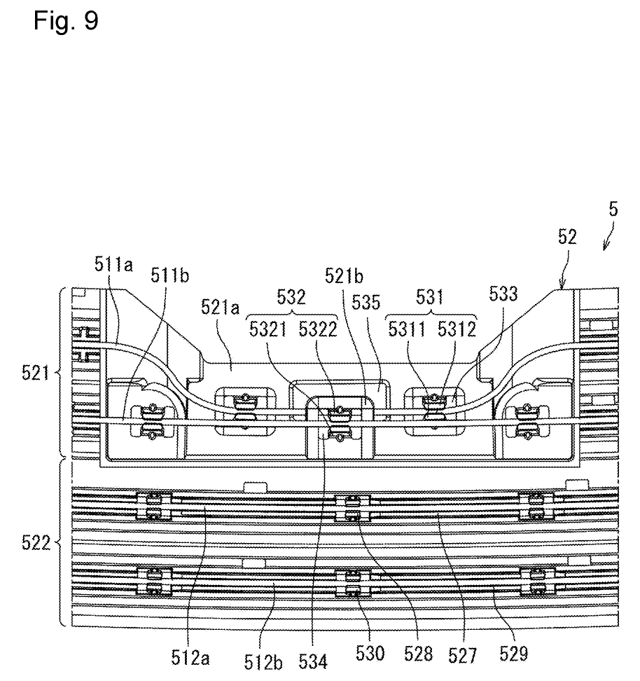

As illustrated in FIGS. 8 and 9, a recessed portion 521a recessed in a direction away from the second supporter 46, that is, recessed upward is provided at a central portion in the longitudinal direction of the lower stage 521 of the sensor bracket 52. A gap between the first front detection portion 511a and the first rear detection portion 511b is adjusted with this recessed portion 521a so that the gap is formed between the first front detection portion 511a and the first rear detection portion 511b. The central portion in the longitudinal direction of the lower stage 521 of the sensor bracket 52 is an example of a portion of the sensor bracket required to face a metal component.

In addition, a plurality of third front holders 531 and a plurality of third rear holders 532 are provided in the recessed portion 521a. When the sensor bracket 52 is attached to the vehicle with the plurality of third front holders 531 and the plurality of third rear holders 532, the first front detection portion 511a and the first rear detection portion 511b are held so that the first front detection portion 511a is located above the first rear detection portion 511b. The third front holder 531 and the third rear holder 532 are each an example of a holder.

Each third front holder 531 is formed by first and second claws 5311 and 5312 facing each other. The first front detection portion 511a is disposed between the first claw 5311 and the second claw 5312. A tip portion of one of the first claw 5311 or the second claw 5312 bulges toward a tip portion side of the other one of the first claw 5311 or the second claw 5312, thereby making it possible to engage with the first front detection portion 511a. In other words, the tip portions of the first and second claws 5311 and 5312 are formed in such a manner as to prevent the first front detection portion 511a from being detached from between the first claw 5311 and the second claw 5312.

In addition, a through hole 533 is provided in the recessed portion 521a in such a manner as to be adjacent to a root portion of each third front holder 531. This makes it possible to visually check whether the first front detection portion 511a is held by the third front holder 531 from the upper surface side of the sensor bracket 52.

Each third rear holder 532 is also formed by first and second claws 5321 and 5322 facing each other. The first rear detection portion 511b is disposed between the first claw 5321 and the second claw 5322. A tip portion of one of the first claw 5321 or the second claw 5322 bulges toward a tip portion side of the other one of the first claw 5321 or the second claw 5322, thereby making it possible to engage with the first rear detection portion 511b. In other words, the tip portions of the first and second claws 5321 and 5322 are formed in such a manner as to prevent the first rear detection portion 511b from being detached from between the first claw 5321 and the second claw 5322.

In addition, a through hole 534 is provided in the recessed portion 521a in such a manner as to be adjacent to a root portion of each third rear holder 532. This makes it possible to visually check whether the first rear detection portion 511b is held by the third rear holder 532 from the upper surface side of the sensor bracket 52.

One of the plurality of third rear holders 532 is provided at a lower end portion of a bulging portion 521b bulging forward from a side portion on the rear side of the recessed portion 521a. An upper end portion of the bulging portion 521b is in contact with the first front detection portion 511a. With this, the downward movement of the first front detection portion 511a is restricted.

In addition, the recessed portion 521a is provided with a through hole 535 in such a manner as to face the through hole 534 at the upper end portion of the bulging portion 521b and the lower end portion of the bulging portion 521b.

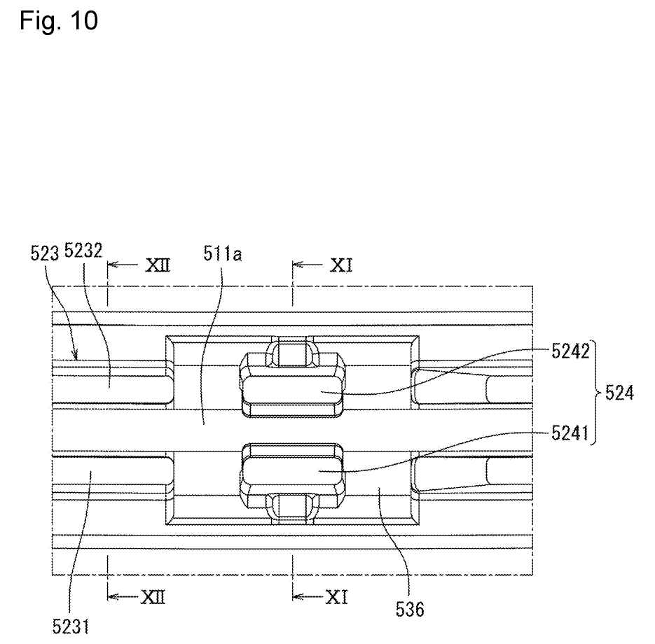

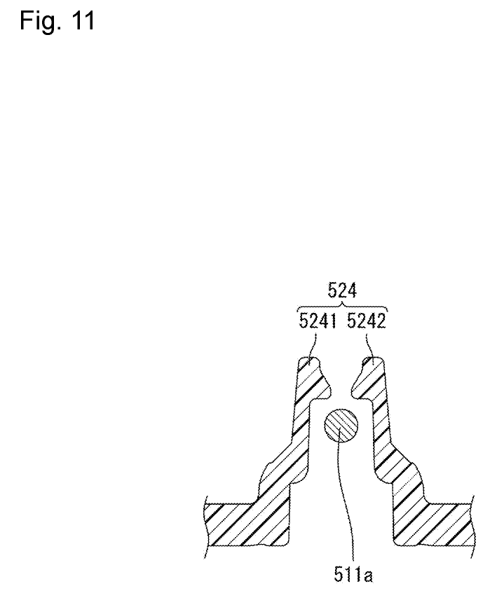

As illustrated in FIGS. 10 and 11, each first front holder 524 is formed by first and second claws 5241 and 5242 facing each other. The first front detection portion 511a is pinched between an intermediate portion of the first claw 5241 and an intermediate portion of the second claw 5242. A tip portion of one of the first claw 5241 or the second claw 5242 bulges toward a tip portion side of the other one of the first claw 5241 or the second claw 5242, thereby making it possible to engage with the first front detection portion 511a. That is, the first and second claws 5241, 5242 of the first front holder 524 are formed in the same manner as the first and second claws 5311, 5312 of the third front holder 531 and the first and second claws 5321, 5322 of the third rear holder 532.

Although not illustrated, the first rear holder 526, the second front holder 528, and the second rear holder 530 are also formed to have the same cross section as the first front holder 524.

A through hole 536 is provided in the lower stage 521 of the sensor bracket 52 in such a manner as to be adjacent to a root portion of the first front holder 524 (see FIG. 10). This makes it possible to visually check whether the first front detection portion 511a is held by the first front holder 524 from the upper surface side of the sensor bracket 52.

Although not illustrated, a through hole is also adjacent to each root portion of the first rear holder 526, the second front holder 528, and the second rear holder 530.

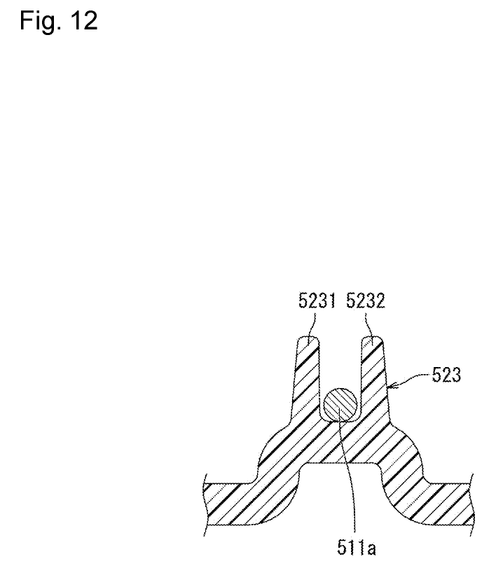

As illustrated in FIGS. 10 and 12, each first front groove 523 includes first and second walls 5231 and 5232 facing each other. The first front detection portion 511a is inserted between the first and second walls 5231 and 5232. The first and second walls 5231 and 5232 are each slightly thinner at the tip portion than at the root portion.

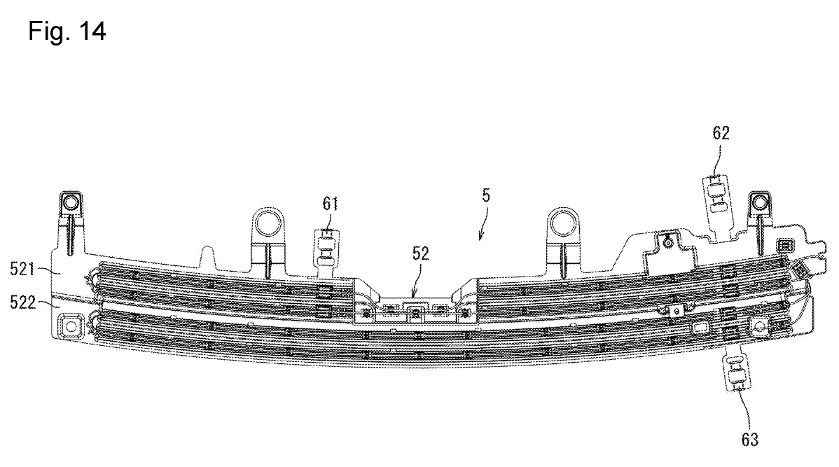

As illustrated in FIG. 14, the first restriction portion 61, the second restriction portion 62, and the third restriction portion 63 are coupled to the edge portion of the sensor bracket 52.

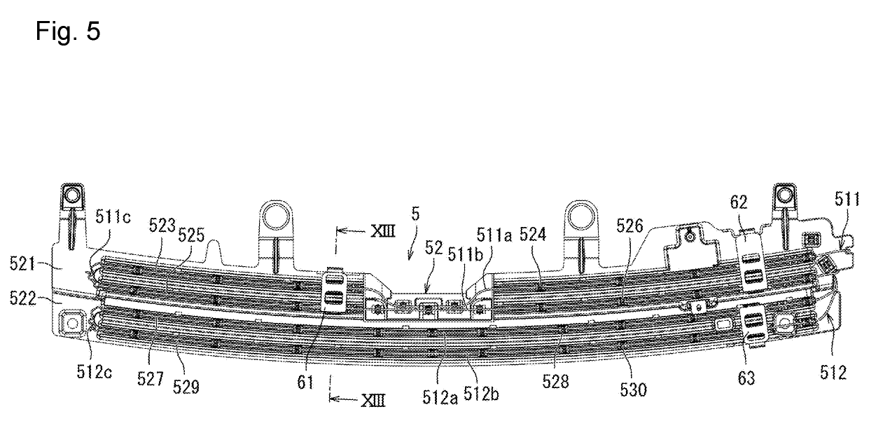

As illustrated in FIGS. 5 and 14, the first restriction portion 61 is rotatable between a non-restriction position and a restriction position. The non-restriction position is a position for positioning the first restriction portion 61 outside the edge portion of the sensor bracket 52 in a state where the first restriction portion 61 does not overlap the sensor bracket 52. The restriction position is a position for pinching the first front detection portion 511a and the first rear detection portion 511b with the sensor bracket 52 in a state of overlapping the sensor bracket 52.

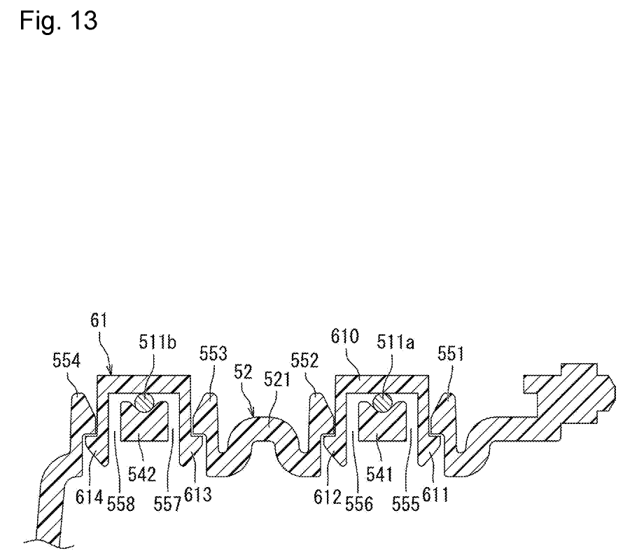

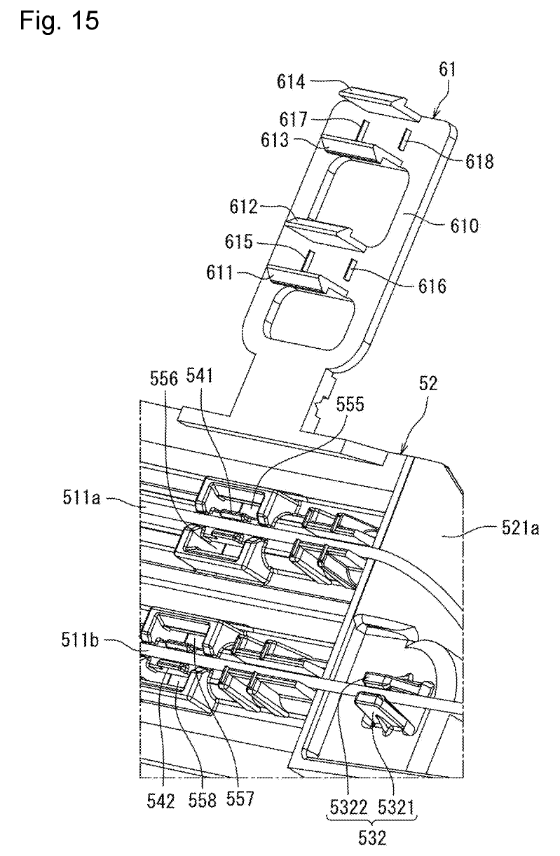

As illustrated in FIGS. 13 and 15, the first restriction portion 61 includes a base portion 610 having a plate-like shape, a first claw 611, a second claw 612, a third claw 613, a fourth claw 614, a first protrusion 615, a second protrusion 616, a third protrusion 617, and a fourth protrusion 618.

The first claw 611, the second claw 612, the third claw 613, and the fourth claw 614 are arranged in this order from the root side of the base portion 610 toward the tip side of the base portion 610. In this case, it can be said that, among the first claw 611, the second claw 612, the third claw 613, and the fourth claw 614, the first claw 611 is located closest to the rotation axis of the first restriction portion 61, while the fourth claw 614 is located farthest from the rotation axis of the first restriction portion 61.

The tip portion of one of the first claw 611 or the second claw 612 bulges toward the opposite side to the tip portion of the other one of the first claw 611 or the second claw 612.

The tip portion of one of the third claw 613 or the fourth claw 614 bulges toward the opposite side to the tip portion of the other one of the third claw 613 or the fourth claw 614.

In the lower stage 521 of the sensor bracket 52, a front pincher 541 and a rear pincher 542 provided rearward relative to the front pincher 541 are provided at a portion overlapping the first restriction portion 61.

A front-end portion of the front pincher 541 is adjacent to a first through hole 555, into which the first claw 611 is inserted. On the other hand, a rear-end portion of the front pincher 541 is adjacent to a second through hole 556, into which the second claw 612 is inserted. That is, the front pincher 541 is provided between the first through hole 555 and the second through hole 556.

A front-end portion of the rear pincher 542 is adjacent to a third through hole 557, into which the third claw 613 is inserted. On the other hand, a rear-end portion of the rear pincher 542 is adjacent to a fourth through hole 558, into which the fourth claw 614 is inserted. That is, the rear pincher 542 is provided between the third through hole 557 and the fourth through hole 558.

In the lower stage 521 of the sensor bracket 52, there are provided a first claw 551, a second claw 552, a third claw 553, and a fourth claw 554.

The first claw 551 and the second claw 552 each have a tip portion bulging toward the front pincher 541 side. With this, when the first and second claws 611 and 612 are inserted into the first and second through holes 555 and 556, the first and second claws 611 and 612 are in a state of being able to engage with the first and second claws 551 and 552. At this time, the first front detection portion 511a is pinched between the front pincher 541 and the base portion 610.

The third claw 553 and the fourth claw 554 each have a tip portion bulging toward the rear pincher 542 side. With this, when the third and fourth claws 613 and 614 are inserted into the third and fourth through holes 557 and 558, the third and fourth claws 613 and 614 are in a state of being able to engage with the third and fourth claws 553 and 554. At this time, the first rear detection portion 511b is pinched between the rear pincher 542 and the base portion 610.

The first and second protrusions 615 and 616 exhibiting lines extending in parallel to each other are provided between the root of the first claw 611 and the root of the second claw 612. The extending direction of the first and second protrusions 615 and 616 is not parallel to the extending direction of the first front detection portion 511a.

A protrusion (not illustrated) exhibiting a line not parallel to the extending direction of the first front detection portion 511a is provided also on a surface facing the first front detection portion 511a in the front pincher 541.

The third and fourth protrusions 617 and 618 exhibiting lines extending in parallel to each other are provided between the root of the third claw 613 and the root of the fourth claw 614. The extending direction of the third and fourth protrusions 617 and 618 is not parallel to the extending direction of the first rear detection portion 511b.

A protrusion (not illustrated) exhibiting a line not parallel to the extending direction of the first rear detection portion 511b is provided also on a surface facing the first rear detection portion 511b in the rear pincher 542.

According to the motion detection device 5 having the above configuration, the recessed portion 521a is provided in a portion of the sensor bracket 52 required to face the metal-made second supporter 46 of the carrier member 4. The recessed portion 521a adjusts a gap between the first front detection portion 511a and the first rear detection portion 511b so that the gap is formed between the first front detection portion 511a and the first rear detection portion 511b, thereby making it possible to prevent the motion detection range of the user's foot from being narrowed in the vicinity of a portion of the sensor bracket 52 required to face the second supporter 46.

In contrast, in a case where there is no gap between the first front detection portion 511a and the first rear detection portion 511b, even when the user's foot enters a space under the second supporter 46, it is difficult to detect the entry of the foot into the space.

Since the recessed portion 521a is recessed in the direction away from the second supporter 46, even when the second supporter 46 vibrates, the second supporter 46 is unlikely to interfere. Therefore, the possibility of the sensor bracket 52 being damaged can be reduced.

Further, when the shape of the recessed portion 521a is set in accordance with the specifications of the second supporter 46 (particularly, the size in the up-down direction of the vehicle), the gap between the first front detection portion 511a and the first rear detection portion 511b can also be easily adapted to the specifications of the second supporter 46, thereby making it easy to secure a necessary detection range for each vehicle.

Since the third front holder 531 and the third rear holder 532 hold the first front detection portion 511a and the first rear detection portion 511b such that the first front detection portion 511a is located above the first rear detection portion 511b when the sensor bracket 52 is attached to the vehicle, even when the sensor bracket 52 is located on the second supporter 46, the first front detection portion 511a can be disposed relatively far from the second supporter 46, and the first rear detection portion 511b can be disposed relatively close to the second supporter 46. Thus, an adverse effect received from the second supporter 46 can be suppressed in the detection of kick motion.

Since the first and second restriction portions 61 and 62 restrict the first front detection portion 511a and the first rear detection portion 511b from moving in the direction away from the sensor bracket 52, it is possible to prevent the detection range of the user's motion from being shifted from a predetermined range.

Since the third restriction portion 63 restricts the second front detection portion 512a and the second rear detection portion 512b from moving in the direction away from the sensor bracket 52, it is possible to prevent the detection range of the user's motion from being shifted from a predetermined range.

The number of components can be reduced by integrally forming the first restriction portion 61, the second restriction portion 62, and the third restriction portion 63 on the sensor bracket 52 rather than separately forming them on the sensor bracket 52. Accordingly, the integral formation of the first restriction portion 61, second restriction portion 62, and third restriction portion 63 on the sensor bracket 52 may simplify the manufacturing process.

Further, since the first restriction portion 61, the second restriction portion 62, and the third restriction portion 63 are each rotatable between the non-restriction position and the restriction position, the positions of the first restriction portion 61, the second restriction portion 62, and the third restriction portion 63 can each be easily switched from the non-restriction position to the restriction position.

The vehicle structure including the motion detection device 5 can prevent a situation in which the motion detection range of the user's foot is narrowed in the vicinity of a portion of the sensor bracket 52 required to face the second supporter 46.

In the above embodiment, the recessed portion 521a is provided in a portion of the sensor bracket 52 required to face the metal-made second supporter 46 of the carrier member 4, but a plane may be employed instead of the recessed portion 521a. In such a case, for example, a pillar may be provided in the above portion, and the pillar may hold the first front detection portion 511a or the first rear detection portion 511b in such a manner that a gap is formed between the first front detection portion 511a and the first rear detection portion 511b.

In the above embodiment, the first front detection portion 511a and the first rear detection portion 511b are formed by using one first electric wire 511, but may be formed by two electric wires, for example. In other words, while the first front detection portion 511a may be formed by part of one electric wire, the second rear detection portion 512b may be formed by part of another electric wire.

In the above embodiment, the motion detection device 5 is fixed to the rear portion of the car body 1 with a bolt or the like, but may be fixed to, for example, the left side portion of the car body 1 with a bolt or the like.

In the above embodiment, the recessed portion 521a of the sensor bracket 52 faces the metal-made second supporter 46 of the carrier member 4, but may face some of the metal components of the car body 1.

Although the specific embodiments of the present disclosure have been described, the present disclosure is not limited to the above embodiments, and various modifications can be made within the scope of the present disclosure.

What is claimed is:

1. A motion detection device comprising:
first and second sensor electrodes that are formed of an electric wire and detect electrostatic capacitance; and
a sensor bracket to which the first and second sensor electrodes are attached, wherein
a gap adjustment portion is provided in a portion of the sensor bracket facing a metal component such that a gap is formed between the first sensor electrode and the second sensor electrode, the gap adjustment portion being configured to adjust the gap between the first sensor electrode and the second sensor electrode.

2. The motion detection device according to claim 1, wherein
the gap adjustment portion is a recessed portion provided in the portion of the sensor bracket required to face the metal component and is recessed in a direction away from the metal component.

3. The motion detection device according to claim 1, wherein
the gap adjustment portion is provided with a holder holding the first and second sensor electrodes such that the first sensor electrode is located above the second sensor electrode when the sensor bracket is attached to a vehicle.

4. The motion detection device according to claim 1, wherein
the sensor bracket is provided with a restriction portion configured to restrict movement of the first and second sensor electrodes in a direction away from the sensor bracket.

5. The motion detection device according to claim 4, wherein
the restriction portion is integrally formed on the sensor bracket.

6. The motion detection device according to claim 4, wherein
the restriction portion is coupled to an edge portion of the sensor bracket, and is rotatable between a non-restriction position for being located outside the edge portion of the sensor bracket in a state of not overlapping the sensor bracket and a restriction position for pinching the first and second sensor electrodes with the sensor bracket in a state of overlapping the sensor bracket.

7. A vehicle structure comprising:
the motion detection device according to claim 1; and
the metal component.

8. The motion detection device according to claim 2, wherein
the gap adjustment portion is provided with a holder holding the first and second sensor electrodes such that the first sensor electrode is located above the second sensor electrode when the sensor bracket is attached to a vehicle.

9. The motion detection device according to claim 2, wherein
the sensor bracket is provided with a restriction portion configured to restrict movement of the first and second sensor electrodes in a direction away from the sensor bracket.

10. The motion detection device according to claim 9, wherein
the restriction portion is integrally formed on the sensor bracket.

11. The motion detection device according to claim 9, wherein
the restriction portion is coupled to an edge portion of the sensor bracket, and is rotatable between a non-restriction position for being located outside the edge portion of the sensor bracket in a state of not overlapping the sensor bracket and a restriction position for pinching the first and second sensor electrodes with the sensor bracket in a state of overlapping the sensor bracket.

12. A vehicle structure comprising:
the motion detection device according to claim 2; and
the metal component.
